(19) United States
(12) Patent Application Publication
(10) Pub. No.: US 2013/0195255 A1
(43) Pub. Date: Aug. 1, 2013

(54) Calibration Phantom Device and Analysis Methods

(71) Applicants: Ricardo Avila, Clifton Park, NY (US); Karthik Krishnan, J.P. Nagar (IN)

(72) Inventors: Ricardo Avila, Clifton Park, NY (US); Karthik Krishnan, J.P. Nagar (IN)

(21) Appl. No.: 13/697,526

(22) PCT Filed: May 10, 2011
(86) PCT No.: PCT/US2011/035816

§ 371 Date: Apr. 2, 2013

Related U.S. Application Data
(60) Provisional application No. 61/334,152, filed on May 12, 2010.

(51) Int. Cl. G01T 1/16

(52) U.S. Cl. CPC G01T 1/16
USPC 378/207

(57) ABSTRACT

This invention relates to a small pocket phantom designed to estimate the fundamental properties of imaging scanning acquisition including 3D resolution, noise, and scanner attenuation performance for different materials, together with an automated phantom analysis algorithm.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### REFERENCE TO A SEQUENCE LISTING

Not applicable.

### BACKGROUND

1. Field of the Invention

This invention relates to a device, system, software, and methods for quantitatively measuring fundamental image acquisition characteristics of a CT scan and collections of CT scans. This can be used for measuring the performance of an individual acquisition, measuring and monitoring the performance of an imaging device, or measuring and monitoring the performance of a collection of images from a set of imaging devices utilized in a clinical study. The methods described here can also be used to perform precise measurements of structures in CT images.

2. Background of the Invention

Calibration of CT scanners has traditionally been performed using a large calibration phantom (e.g. Catphan phantom, Phantom Laboratory, Salem, NY) designed to measure a series of fundamental properties of an image acquisition system or scanner. Scanner calibration typically involves placing a traditional calibration phantom on the CT table, scanning it using a prescribed set of conditions, and manually measuring acquired images of the phantom to obtain properties of the scanner. Calibration measurements are compared against expected values and steps are taken to adjust the acquisition device if calibration results are not within specified tolerances. The process involves a significant amount of manual labor and, as a result, a calibration is performed at intervals of weeks or months. In addition, the performance of the acquisition device is not transmitted to downstream clinical applications which could use the acquisition characteristics to perform improved performance such as improved disease detection and/or measurement.

This approach to calibration does not provide calibration information such as resolution, noise, and CT number bias for an individual CT scan. This is because there are a large number of parameters that are set to acquire a CT image and each can impact the performance of an individual acquisition. In addition, the object or subject/patient in the CT scan will modify the noise and other properties of the acquisition, making the fundamental characteristics of each acquisition slightly different.

It has recently been proposed that a small “pocket phantom” placed on or near a patient (or object) and simultaneously scanned with the patient (or object) could provide an estimate of the fundamental imaging characteristics for each CT acquisition. Several small devices have been developed and tested with limited success. All attempts to capture the fundamental performance of an individual CT acquisition have suffered from several problems.

First, the performance of an acquisition is highly dependent on the position at which the measurement is taken with respect to the center of rotation (isocenter) of the CT scanner. Thus a calibration measurement must always be compared to a reference measurement that was acquired with similar conditions and at the same distance from isocenter to determine if the individual CT acquisition is within an acceptable performance range. To avoid this complexity, most traditional calibration phantoms obtain measurements at a fixed distance and close to isocenter and therefore do not fully characterize the spatial variation present in a CT acquisition.

Second, calibration devices made to date have viewed calibration as the measurement of a finite series of separate measurements such as in-plane resolution, trans-axial resolution, noise, and CT linearity. This approach does not attempt to integrate all of these measurements into a working model of the acquisition device.

Third, the devices still require a great deal of time and effort to manually locate and measure individual phantom components.

Fourth, the devices can be expensive to manufacture since they require extraordinary manufacturing precision to manufacture identical devices with a specified geometry.

Fifth, the time resolving performance of the scanner is often not measured.

Sixth, the phantom designs have not been designed to be easy to clean and also withstand the demanding conditions of a clinical scanning operation. This requires that the device is rugged, can be dropped, scratched and mishandled and retain its long-term dimensional, x-ray attenuation, and other properties.

Seventh, the results of phantom analysis have not been provided to downstream applications that can make use of the fundamental characteristics of the individual acquisition to provide improved measurement information to a user performing measurements.

Eighth, the estimated performance of an acquisition system is represented with high complexity. However, downstream applications can get the most benefit from simple descriptions of system characteristics. For example, a PSF sigma that characterize the resolution of a scanner is preferable to a full Modulation Transfer Function representation since the latter has so many degrees of freedom it is difficult to identify how an edge detector should integrate and adapt to the information. However, a single sigma value can be more easily translated into known biases for purposes of correction.

### BRIEF SUMMARY OF THE INVENTION

In a preferred embodiment, a device designed to obtain the fundamental performance characteristics of each subcomponent of an imaging system at a precise spatial location using a virtual acquisition pipeline model, further comprising wherein said device:
a. is capable of measuring performance characteristics of PSF convolution, artifacts, noise and edge enhancement;
b. may be used in a variety of optical image scanning devices, including but not limited to CT, PET/CT, PET, MR, US, XR and NM; and
c. further comprises components for multi-energy x-ray performance analysis.

In another preferred embodiment, said device further comprising identifying numerical information within the phantom that is visible in the acquired image, including but not limited to a model number and serial number.

In another preferred embodiment, said device further comprising numerical or other, similar identifying character information within the phantom that is visible in the acquired image user settable settings, including but not limited to rotary dials.

In another preferred embodiment, said device further comprising wherein one or more such devices embed in the table upon which the patient or subject rests during image scanning, and provide a continuous set of virtual acquisition models along the length of said table.

In another preferred embodiment, said device further comprising wherein moving components are contained within the device to obtain 4D characteristics of an image acquisition, including the 4D PSF.

In a preferred embodiment, a method, e.g. using a software algorithm, for automatically detecting the said device and estimating the performance characteristics of an image acquisition device, further comprising:
a. a virtual acquisition model and an model optimizer; and
b. the ability to detect and read numerical or other characters.

In another preferred embodiment, said method or algorithm further comprising the ability to measure and access information such as geometry and attenuation performance of one or more scanned calibration devices.

In another preferred embodiment, said method or algorithm further comprising ability to combine information on the make, model and geometry of one or more scanned calibration devices and a virtual acquisition model from identified calibration devices to produce a full 3D description of the virtual acquisition model variation throughout the scan.

A system comprising said device and said algorithm, set to accept images of one or more said devices, automatically analyze such images, and allow an individual to monitor the system and study performance over time, further comprising wherein,
said system produces periodic reports evidencing acquisition performance characteristics as well as performance and error levels at multiple imaging tasks, including but not limited to:
spatial and time measurement of length, area, volume in 3D and 4D moving objects; and
detection of different sized and shaped objects relevant to clinical studies;
said system produces periodic reports evidencing performance of scan protocols, individual machines, or a particular study at one time or over a time duration; and
protocols allowing a user to set performance limits to trigger user notifications and alerts.

In a preferred embodiment, a 3D/4D interpolation method or algorithm that utilizes a spatially varying virtual acquisition model to more accurately interpolate between samples and provide the amount of variability at each continuous location in the image.

In a preferred embodiment, a 3D/4D measurement method or algorithm that uses a spatially varying virtual acquisition model to more precisely measure distance, area and volume, and also reports minimum error bounds/confidence intervals for these measurements.

A disease detection or risk assessment method or algorithm that utilizes a spatially varying virtual acquisition model to identify anatomy and pathology, or structural changes.

### BRIEF DESCRIPTION OF THE DRAWINGS

FIG. 1 is a drawing of two line graphs. FIG. 1 shows how uncorrected intensity values can provide misleading information in contrast to corrected values showing 95% confidence intervals.

FIG. 2 is a drawing of two line graphs. FIG. 2 shows that within the corrected bias and variance that an intensity value of 3.0 may be more accurately found over a range.

FIG. 3 is line graph. FIG. 3 shows an analysis of the FVAM at the location of the measurement provides information on why the measurement has given a level of uncertainty and what could be done to achieve higher measurement performance. It could be that there was too little resolution, too much noise, or the image sampling was too low. Adjusting all three could give the measurement performance desired.

FIGS. 4, 5, 6, 7 and 8 show a series of calibration phantom designs with different calibration device features.

FIG. 4 shows the design of the initial phantom developed, manufactured, and tested, which consists of a precision manufactured acrylic sphere with a diameter of 15.875 mm, a Delrin sphere at with a diameter of 15.875 mm, and a Teflon sphere with a diameter of 15.875 mm. All three spheres are embedded within 45 mm by 105 mm of Urethane material.

FIG. 5 shows a similar phantom design as FIG. 4, but also has four sets of three periodically spaced cylindrical holes that can be filled or unfilled with cylindrical urethane plugs, or other materials, to create a binary, machine readable representation of a number. This number can represent the model number and serial numbers on the calibration device.

FIG. 6 shows an alternative calibration device design with the addition of rotary dials that allow a user to encode a number into the CT scan data.

FIG. 7 shows an alternative design that contains additional spheres that provide the imaging system response to materials that will respond differently to different x-ray energy levels. In this design, we have utilized spheres consisting of calcium and iodine based materials, two substances that are commonly used in x-ray imaging.

FIG. 8 shows an alternative CT calibration device design that contains rotating spheres, each sphere also containing small spherical markers. The rotating spheres provide a way to illustrate the amount of motion blur in the CT scan. The small spheres will be placed within the larger sphere such that each will have different velocities. The spheres will be driven by a battery operated motor or driven by another form of force, such as moving liquid or air. The calibration device may also include periodically spaced objects or voids to represent a binary number or optional user-set rotary dials to present number indicia or additional spheres.

FIG. 9 is a representation of an array of phantom devices embedded within or placed on the CT table itself. FIG. 9 shows an optional outer structure or shell that is designed to take the patient load, allowing each device to last longer with such a design. FIG. 9 shows that placing another individual phantom with the patient would provide another data point in addition to the embedded phantoms for determining CT acquisition performance.

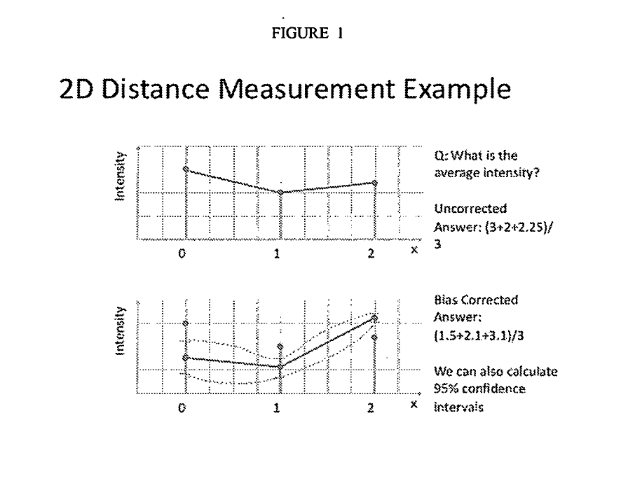

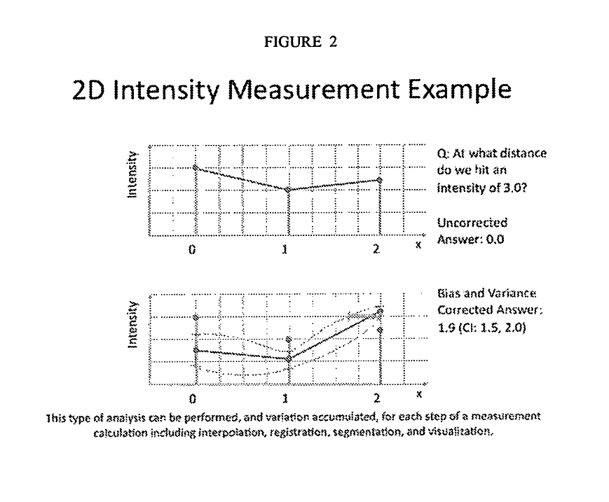

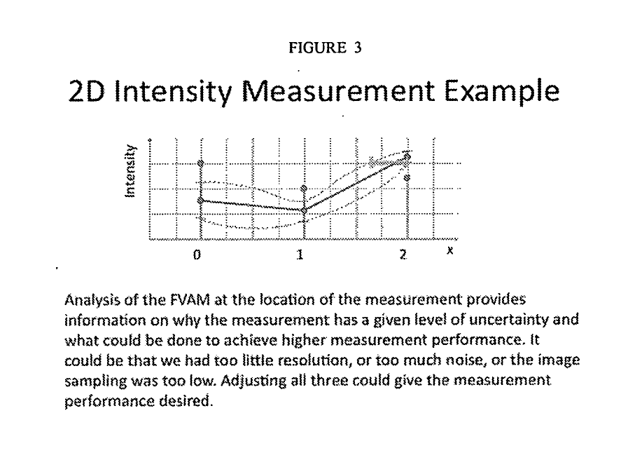

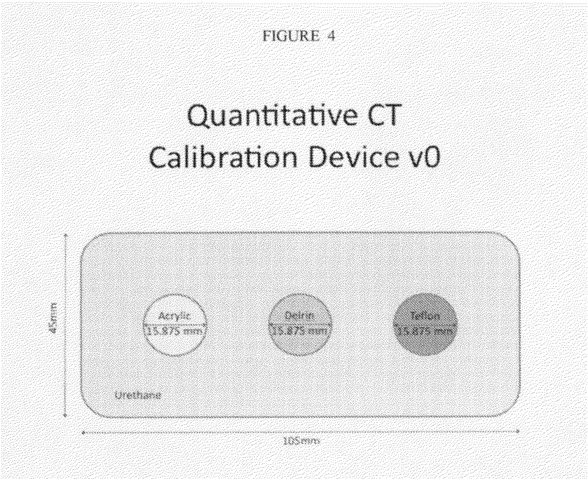

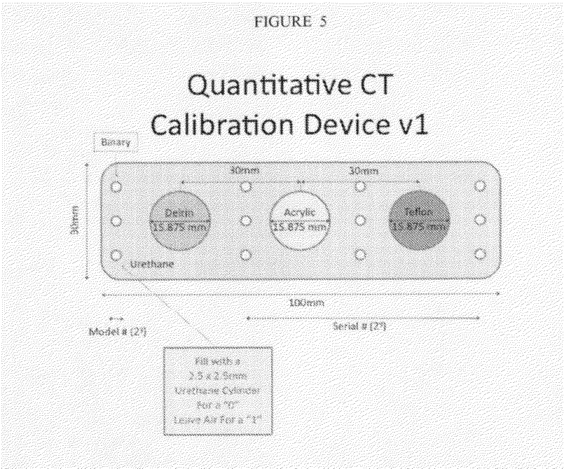

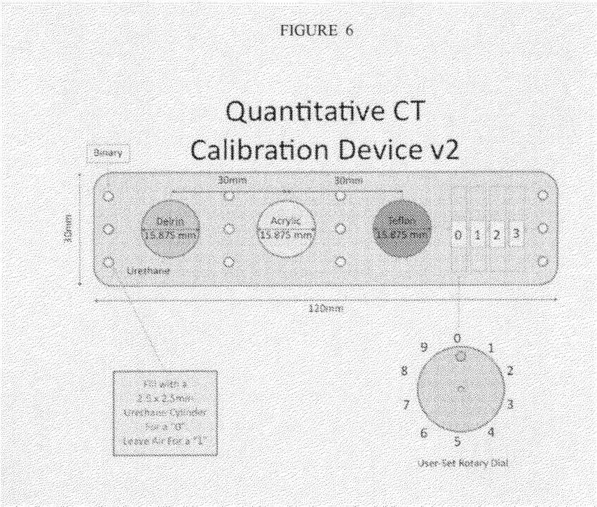

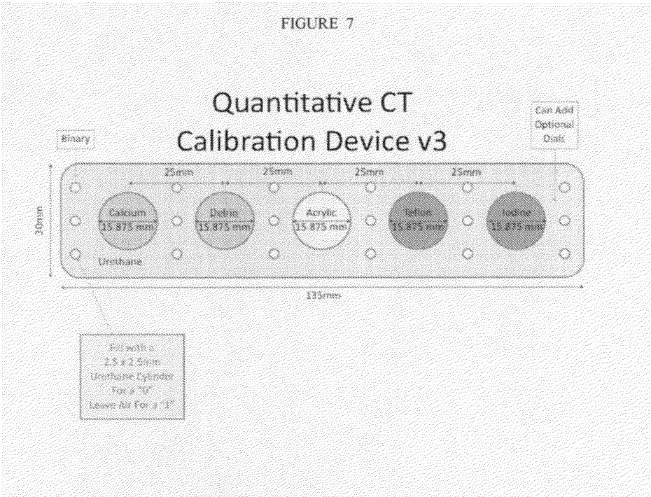

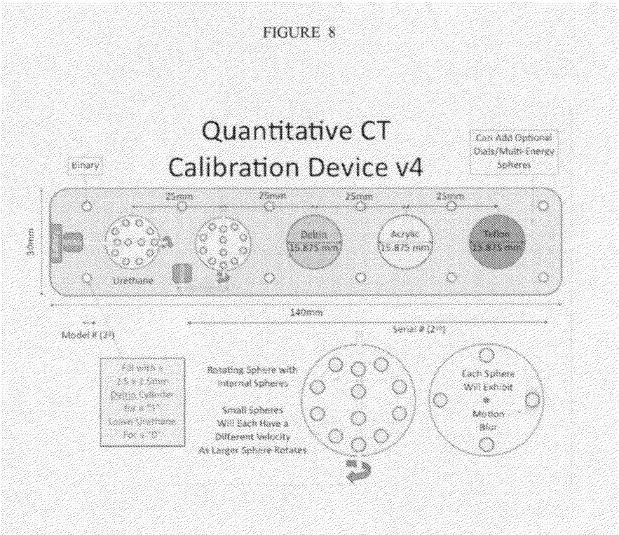

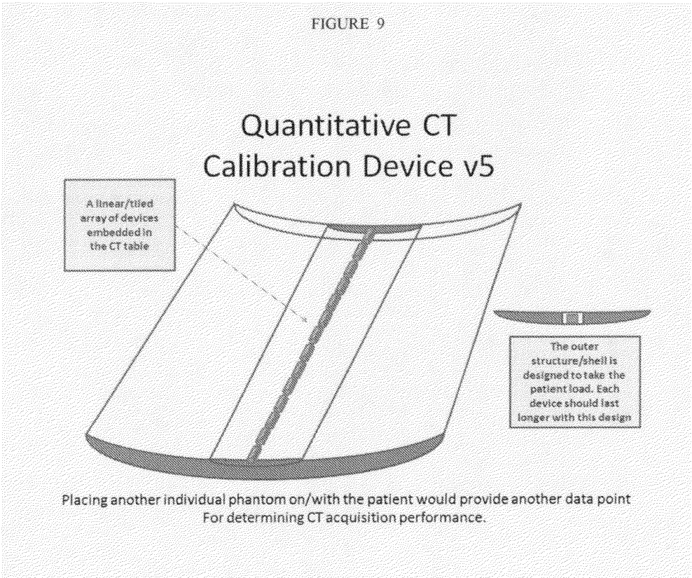

### DETAILED DESCRIPTION OF THE INVENTION

One aspect of the present invention is directed to a virtual model that optimizes the scanned information received from a radiologic device such as a CT scanner by taking into account the variations that occur during scanning whereby the scanner reports different values at different distances from the center of a scan. Such a model comprises a set of values stored within a database and which can be used to correct or optimize the actual values generated during a radiologic scan such as a CT scan.

In another aspect, the database is updated with each new scan performed.

In another aspect, the database is created by scanning a pocket phantom, or small scannable device, that provides resolution and other information about the performance of the scanner being used.

In another aspect, the scannable device or phantom may have detectable indicia, such as a serial number. In another aspect, the phantom has a moving part integrated in it that, when moving at a constant rotational velocity, provides for capturing the time resolving capability of the imaging device.

Definitions

The following definitions are provided as an aid to understanding the detailed description of the present invention.

The phrase “3D” as used herein, refers to the simultaneous imaging and/or measurement of height, width and depth of an object.

The phrase “4D” as used herein, refers to the simultaneous imaging and/or measurement of height, width, depth of an object over a set period of time.

“Dosimeter”, as used herein, means a device used to measure an absorbed dose of ionizing radiation.

The acronym “PSF” as used herein, refers to point spread function, which term describes the response of an imaging system to a point source or point object. A more general term for the PSF is a system's impulse response, the PSF being the impulse response of an image acquisition system.

The device is a small pocket phantom designed to estimate the fundamental properties of a CT acquisition including 3D resolution, noise, and CT attenuation performance for different materials.

A related, automated analysis algorithm also has been developed that will automatically identify all phantoms within a CT scan, find and identify the model and serial number of the phantom, and solve for a virtual acquisition system model that estimates the performance of the image acquisition system at all locations within the image. The virtual acquisition model will take the estimated performance characteristics of a single or multiple devices in the image and combine this with aggregated information stored on the spatial variation of the acquisition model and parameters used.

An automated phantom analysis algorithm that uses an optimizer to estimate the characteristics of a virtual acquisition model (with respect to the actual acquisition data) to arrive at the performance of a CT acquisition. In one embodiment, the optimizer optimizes the 3D position of a sphere and the sigma values of a 3D point spread function.

An automated phantom analysis algorithm that uses an optimizer to estimate the characteristics of a virtual acquisition model (with respect to the actual acquisition data) to arrive at the performance of a CT acquisition. In one embodiment, the optimizer optimizes the 3D position of a sphere, the sigma values of a 3D point spread function along with any edge enhancing terms in the PSF. The algorithm automatically detects the spheres. It then segments the sphere and evaluates the average density within the sphere. The density of the surrounding phantom material is also estimated automatically. Armed with this information, and the knowledge of the precision machined sphere geometry, a CT scan of the sphere is simulated in software, resulting in a virtual acquisition model (VAM). The optimizer iteratively finds the PSF that best matches the VAM to the scanned image by minimizing the mean square error between the two images.

In another embodiment, the spheres contained in the phantom are grooved, ridged, patterned or otherwise marked to provide the algorithm with more precise markers for higher precision measurement and calibration.

In another embodiment, an arbitrarily shaped object is used in place of a sphere.

Moving components within the calibration phantom will provide a fourth dimension of time resolution performance for an acquisition. The virtual acquisition model is optimized over time as well as static parameters of an acquisition.

Another potential aspect of a calibration phantom is the inclusion of a dosimeter to measure the amount of radiation expended during a CT scan at a specific point on the CT table. Such a dosimeter might, for example, comprise a nanodot or plurality of nanodots (Landauer Inc.) made from poly-methylmethacrylate (ppm) or another similar radiation-sensitive material or plurality of materials. Such dosimeters may be embedded within the phantom or attached to the phantom's exterior to allow for use and replacement thereof.

A single elongated or a series of pocket phantom-like devices can be embedded or placed on the CT table to provide a virtual acquisition system model at all positions along a CT table.

A central monitoring system that accepts images, identifies images with phantoms, and monitors performance on individual scans, individual acquisition devices, individual protocols, or specific studies being performed on a collection of image acquisition devices. The monitoring system can be set up to accept performance limits/ranges and send out alerts/reports when performance issues are identified. This can be integrated with analysis of traditional calibration phantoms to provide a full system for periodic and continuous image acquisition performance monitoring.

In one aspect, a foam container with multiple pocket phantoms is placed on a CT table where calibration phantoms are located at varying set distances at or from the isocenter of the scan. The scan is performed with varying protocols based on the type of scanner. Software prepared according to the present invention, and running in memory of a computer integrated with the scanner, collects and analyzes the datasets in an automated manner and combines this with information from a central database containing information on the same or similar scanners. Some of the information that is included regarding a specific scanner includes geometry, attenuation, and performance. The ability to combine information on the make/model/geometry of the acquisition device and a virtual acquisition model from identified phantoms provides for estimation of a full 3D description of the virtual acquisition model variation throughout the CT scan.

In another aspect, there is provided a device designed to obtain the fundamental performance characteristics of each subcomponent of an imaging system at a precise spatial location using a virtual acquisition pipeline model. The model is intended to take into account PSF Convolution, Artifacts, Noise, Edge Enhancement, in order to optimize scanning performance. It is contemplated as within the scope of the invention that this is applied to CT, PET/CT, PET, MR, US, XR, and NM radiologic machines, and also include components for multi-energy x-ray performance analysis. The invention may also be applied to optical imaging devices. The addition of identifying numerical information within the phantom that is visible in the acquired image such as Model #, Serial #, or user settable settings (e.g. rotary dials) is included within the invention. A further aspect includes a calibration device that embeds in or sits on the CT table and provides a continuous set of virtual acquisition models along the length of the table.

During scanning, a patient or an object is placed on the CT table with one (preferable) or more phantoms at different distances from iso-center. As stated, one of these phantoms could be a full table length phantom embedded in the CT table. Automated phantom analysis finds and measures each phantom and produces a report on a virtual acquisition model at the location of each phantom within this individual scan. A virtual acquisition model (VAM) is a best fit of a functional simulation of the image acquisition device at the position of the pocket phantom.

It is believed that a novel aspect is in the construction of a Virtual Acquisition Model (VAM) and how the VAM is used. The VAM essentially simulates the steps taken to construct an image with a simplified acquisition pipeline and modeling mathematics. It is meant to largely capture the fundamental functioning of the scanner with minimal complexity. For example, a CT acquisition system can be considered a pipeline involving a) convolution with a gaussian kernel, b) the addition of noise, and c) the application of a post-processing “edge enhancement” filter. Other steps can be added, such as image artifact models.

In one aspect, QA analysis software stores each VAM obtained within a constantly updated local as well as central database. QA analysis software compares each VAM obtained against previously acquired information for the scanner and scan acquisition settings and determines if the image acquisition is operating within acceptable performance limits for the healthcare institution.

As each QA analysis is performed, a full 3D+time VAM is updated for the full range of acquisition parameter settings for a scanner. This full VAM (FVAM) for the scanner is compared against a global database of scanner performance FVAMs and determines if the scanner is operating within acceptable performance limits for the healthcare institution.

In another aspect, QA analysis software compares each virtual acquisition model constructed against previously acquired information for the scanner and scan acquisition settings and determines if the image acquisition is operating within acceptable performance limits for a clinical study.

In a further aspect, the institution running the study is then able to compare the performance of the obtained image acquisitions against other similar devices or different models allowing the institution to make well informed study design and imaging study purchase decisions. A specific FVAM is constructed for a single image acquisition. A continuous 3D model of scanner bias and standard deviation is constructed. When analysis is performed in a clinical application, the bias and standard deviation is calculated and displayed.

In another aspect, a reporting system is included that comprises a system that accepts images with the device, automatically analyzes the images, and allows an individual to monitor system/study performance over time. From this, Reports are generated that show acquisition performance characteristics as well as performance and error at different tasks, such as (a) Measurement: Length, Area, Volume in 3D and 4D moving objects, and (b) Detection: Different size and shape objects relevant to clinical studies. Other reports showing performance of scan protocols, individual machines, or a particular study at one time or over a time duration may also be generated, along with user settable performance limits that trigger notifications and alerts.

Another advantage includes a 3D/4D interpolation algorithm that utilizes a spatially varying virtual acquisition model to more accurately interpolate between samples and provide the amount of variability at each continuous location in the image. Alternatively, there is provided a 3D/4D measurement algorithm that uses a spatially varying virtual acquisition model to more precisely measure, distance, area, volume, etc. and reports minimumerror bounds/confidence intervals. Another feature includes a detection algorithm that utilizes a spatially varying virtual acquisition model to better identify anatomy and pathology.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

We claim:

1. A device designed to obtain the fundamental performance characteristics of each subcomponent of an imaging system at a precise spatial location using a virtual acquisition pipeline model, further comprising wherein said device
a. is capable of measuring performance characteristics of PSF convolution, artifacts, noise and edge enhancement;
b. may be used in a variety of optical image scanning devices, including but not limited to CT, PET/CT, PET, MR, US, XR and NM; and
c. further comprises components for multi-energy x-ray performance analysis.

2. The device of claim 1 further comprising identifying numerical information within the phantom that is visible in the acquired image, including but not limited to a model number and serial number.

3. The device of claim 1 further comprising numerical or other, similar identifying character information within the phantom that is visible in the acquired image user settable settings, including but not limited to rotary dials.

4. The device of claim 1 further comprising wherein one or more such devices embed in or rest on the table upon which the patient or subject or object rests during image scanning, and provide a continuous set of virtual acquisition models along the length of said table.

5. The device of claim 1 further comprising wherein moving components are contained within the device to obtain 4D characteristics of an image acquisition, including the 4D PSF.

6. The device of claim 4 further comprising wherein a dosimeter is contained within or attached to the device.

7. The device of claim 4 further comprising wherein components within the device are grooved, ridged, patterned or otherwise marked to provide the algorithm with more geometrically varied objects for robust precision measurement and calibration.

8. An algorithm for automatically detecting the device and estimating the performance characteristics of an image acquisition device, further comprising:
a. a virtual acquisition model and an model] optimizer; and
b. the ability to detect and read numerical or other characters.

9. The algorithm of claim 6 further comprising the ability to measure and access information such as geometry and attenuation performance of one or more scanned calibration devices.

10. The algorithm of claim 6 further comprising ability to combine information on the make, model and geometry of one or more scanned calibration devices and a virtual acquisition model from identified calibration devices to produce a full 3D description of the virtual acquisition model variation throughout the optical scan.

11. A system comprising the device of claim 1 and the algorithm of claim 6 to accept images of one or more said devices, automatically analyze such images, and allow an individual to monitor the system and study performance over time, further comprising wherein
a. said system produces periodic reports evidencing acquisition performance characteristics as well as performance and error levels at multiple imaging tasks, including but not limited to
i. spatial and time measurement of length, area, volume in 3D and 4D moving objects; and
ii. detection of different sized and shaped objects relevant to clinical studies.
b. said system produces periodic reports evidencing performance of scan protocols, individual machines, or a particular study at one time or over a time duration; and
c. protocols allowing a user to set performance limits to trigger user notifications and alerts.

12. A 3D/4D interpolation algorithm that utilizes a spatially varying virtual acquisition model to more accurately interpolate between samples and provide the amount of variability at each continuous location in the image.

13. A 3D/4D measurement algorithm that uses a spatially varying virtual acquisition model to more precisely measure distance, area and volume, and also reports minimum error bounds/confidence intervals.

14. A disease detection or risk assessment algorithm that utilizes a spatially varying virtual acquisition model to identify anatomy and pathology.
